(19) United States
(12) Patent Application Publication
(10) Pub. No.: US 2023/0408782 A1
(43) Pub. Date: Dec. 21, 2023

(54) FIBER INSULATOR WITH FIBER OPTICAL CABLE

(71) Applicant: Weinert Industries AG, Föritztal (DE)

(72) Inventors: Marcus Bloom-Pflug, Neu-Ulm (DE); Juntao Deng, Changzhou, Jiangsu (CN)

(73) Assignee: Weinert Industries AG, Föritztal (DE)

(21) Appl. No.: 18/035,501

(22) PCT Filed: Nov. 5, 2020
(86) PCT No.: PCT/CN2020/126710

§ 371 Date: May 4, 2023

(51) Int. Cl. G02B 6/44

(52) U.S. Cl. CPC G02B 6/4431

(57) ABSTRACT

A fiber insulator (100) with a fiber optical cable (200) is provided. The fiber insulator (100) comprises a fiber optical cable (200); a ceramic jacket (120), wherein the ceramic jacket (120) is hollow, wherein the ceramic jacket (120) has an inner whole diameter (D) configured to guide the fiber optical cable (200); an insulating filling material (130), which at least partially fills out the ceramic jacket (120) and is arranged between the fiber optical cable (200) and the ceramic jacket (120), wherein the insulating filling material (130) has thermal properties similar to the thermal properties of the fiber optical cable (200) and the ceramic jacket (120), and wherein at least one end of the fiber insulator (100) is closed by at least one end cap (151, 152).

### FIELD OF THE INVENTION

The invention relates to a fiber insulator with a fiber optical cable for use with applications for direct measurement methods on medium and high voltage breaking-closing disconnecting switches.

### PRIOR ART

A transmission of signals and or data in controlled (indoor) high voltage environments can already be done via fiber optics. In order to bridge significant potential differences, specific jacket materials can be used. Moreover, these materials are mainly used in inside areas such as transformers (closed environment), valve rooms (closed, humidity controlled environment) and others.

Transmission of fiber optical signals and data in mid and high voltage environments can be done by so called fiber insulators. The main application in the field can be found in long distance fiber transmission in combination with high voltage lines. Therefor so called ADSS cables are used to transmit fiber optical telecommunication signals. At the start and end point of the high voltage line the fibers have to be connected to the ground level. This can be done via various fiber insulators in order to bridge up to 1200 kV. Nevertheless these are fixed installations, means there is no significant movement of the insulators itself involved.

A further application of fiber insulators can be found in medium and high voltage transformer stations. Various different equipment's have to be connected to fiber optical signal transmission. All these applications are fixedly installed and thereof cannot be moved. Such moving would have an impact due to mechanical impacts on the optical signals.

In medium and high voltage areas, signals and data have to be transmitted in optical fibers from the measurement point to a main control cabinet on the ground level. This could either be done by wireless data transmission or by a wired signal and data transmission.

### Technical Problem

For a wireless transmission the main challenge lies in the power supply for the sensor systems as well as continues interruption free connection in any weather condition. A further challenge lies in the difficulty and the acceptance of self-powered systems in this high voltage environment. Therefor this method has its limits.

A standard, copper wire based sensor solution is not applicable due to the potential difference of the sensor and the receiving electronics (ground level to >50 kV at the sensor position). Therefor the only option is to use fiber optical based data and signal transmission.

A further challenge is the outdoor and harsh environment in which the disconnecting switches are usually located. The environment can have temperatures ranging from minus 50 to plus 85 degree Celsius. Furthermore humidity, sand, mud, heavy rain and thunder storms, air pollution and other negative environmental factors have to be considered.

A pure cable connection from a ground level to levels >50 kV (potential difference) has problems such as partial discharges and creeping currents as well as environmental factors.

The inventors of the present invention found that a partial discharge is happening with nearly all cables in such environments after a certain life time, mainly due to the aging of cable materials and residuals/sediments from environmental influences (e.g. air pollution, moss and others).

A cable connection can be done with a so called fiber insulator, a hollow insulator made out of either ceramics or silicone. Silicon insulator are facing several technical difficulties as described in public available researches. Nevertheless they would be the best choice in combination with a cable, in terms of manufacturing challenges, shrinkage, etc. In order to overcome such difficulties, a traditional ceramic insulator in combination with a fiber feedthrough might be the preferred option.

The third and most difficult to overcome challenge is that switches contain moving parts, especially the isolator itself is moved and turned together with connecting arms of a Breaking-closing disconnecting switch (BCDS) in order to perform it's on and off function. This will lead to a significant repeated torsion on optical fibers while being used for signal and data transmission. With an ordinary cable, this torsion will heavily influence the optical performance of the fibers and thereof negatively influence the sensing signals.

Based on this fact a tension and bending resistant cable as well as a connection of the cable to the isolator has to be developed.

### Solution

The inventors of the present invention developed a fiber insulator with a fiber optical cable to achieve a transmission of signal and data in a reliable and high performing way fitting to the life time of the medium and high voltage (disconnecting-) switches.

The invention solves one or more of the aforementioned problems by a fiber insulator with a fiber optical cable as defined by independent claim 1. Specific embodi-ments are further defined by the dependent claims.

According to an embodiment of the invention, there is provided a fiber insulator with a fiber optical cable, comprising a fiber optical cable and a ceramic jacket, said ceramic jacket being hollow. The ceramic jacket has an inner whole diameter configured to guide the fiber optical cable. The fiber insulator further comprises an insulating filling material, which at least partially fills out the ceramic jacket and is arranged between the fiber optical cable and the outer ceramic jacket. Moreover, at least one end of the fiber insulator is closed by at least one end cap configured to close the at least one end of the fiber insulator, wherein the at least one end cap is configured such that the fiber optical cable passes through the at least one end cap.

Preferably, the at least one end cap is configured to be fixed to an outer surface or outer layer of the fiber optical cable, such as a yarn covering a (hollow) tube of the fiber optical cable or a non-corrosive jacket covering the yarn, to prevent movement of the fiber optical cable along the fiber optical cable extension direction and/or re-duce/prevent torsion applied to the fiber optical cable to be transferred to a fiber of the fiber optical cable.

The insulating filling material may fill out most of, preferably may completely fill out the hollow inner space between the fiber optical cable and the hollow ceramic jacket.

The ceramic jacket can have the inner whole diameter configured to guide the fiber optical cable. That is, the ceramic jacket may extend along an extension direction to cover a certain length of the fiber optical cable. The fiber optical cable can be fed into the hollow ceramic jacket via the at least one end cap and the fiber optical cable will be guided along the extension direction by the ceramic jacket.

The extension direction of the fiber insulator/ceramic jacket may at least be partially the same as an extension direction of the optical fiber cable, or may be different.

Here, an end of the fiber insulator is to be understood as either a beginning or an end of the fiber insulator when viewed along the extension direction of the fiber insulator and the fiber insulator may extend from one end to the other end thereof.

In order to achieve an improved performance and isolation function of the fiber insulator in the described harsh environment, the hollow ceramic jacket as described above is suggested, wherein the inner space of the insulator can be filled or filled out with the filling material.

The insulating material can have thermal properties configured to compensate thermal properties of at least one of the fiber optical cable and the ceramic jacket. Preferably, the insulating material may have the thermal properties configured to compensate the thermal properties of both the fiber optical cable and the ceramic jacket. In other words, the insulating material may have the thermal properties configured such that a change of temperature from the environment of the fiber insulator and/or a high/low temperature of the environment is not transmitted via the insulating material to the fiber optical cable in order to prevent any damage and affection of the fiber optical cable or a fiber of the fiber optical cable from temperature changes and/or high temperatures (such as below 0° C. or above 100° C.).

Furthermore at least one end, preferably both ends of the insulator may be closed with end caps in order to protect the filling material as well as making the filling process possible.

An outer surface of the ceramic jacket can have an undulating shape and an inner surface of the ceramic jacket may face the fiber optical cable. Moreover, the inner surface of the ceramic jacket may have a smooth surface extending along the extension direction of the fiber insulator. This provides the technical effect that a creepage distance can be increased a lot compared to a smooth outer surface (smooth rob).

The long creepage distance will contribute to the insulation level of the fiber insulator.

The insulating filling material can have thermal properties similar to the thermal properties of the fiber optical cable and the ceramic jacket. Thereby, an improved insulating function is achieved.

The at least one end cap may be configured to seal the end of the insulator. Thereby, protection from the environment can be achieved.

Here, a seal function has the typical meaning within the state of the art of sealing, e.g., an opening of an insulator can be sealed such that a fluid and/or gas cannot pass through the seal. Accordingly, the insulator can be shielded against fluids or gases, which would otherwise pass into the insulator or come out from the inside of the insulator.

The at least one end cap can have a fiber optical cable opening. The fiber optical cable opening may be arranged such that the fiber optical cable can pass through the fiber optical cable opening into the fiber insulator (and into the hollow jacket). As an option, the fiber optical cable opening may be configured to seal with the fiber optical cable when the fiber optical cable passes through the fiber optical cable opening.

The at least one end cap can be detachably coupled with the at least one end of the fiber insulator.

By providing at least one end cap, it is possible to firstly fill in the filling material into the ceramic jacket via the at least one end, and, after filling in the filling material, the end cap can be arranged at or in the at least one end to prevent the filling material from coming out of the insulator and to protect the filling material. Moreover, by appropriately choosing the diameters of the at least one end and the at least one end cap, an efficient filling process can be achieved compared to the case when the filling material is input via, e.g., the fiber optical opening which has a smaller diameter compared to a diameter of the at least one end cap.

The end of the insulator can have a square like form when viewed in a cross section extending along an extension direction of the fiber insulator. When viewed in the cross section, the square like form may have a front surface and a rear surface parallel to the front surface and said front and rear surfaces may be connected by side surfaces. When viewed in the cross section, there may be two side surfaces connecting the front and rear surfaces. Of course, when viewed in a three dimensional manner, at least four side surfaces may exist connecting the front and rear surfaces. The fiber insulator may extend from the front surface of the square like form along the extension direction. In other words, the fiber insulator may have a first end and a second end when viewed along the extension direction. The fiber insulator may extend from the first end to the second end. The first end may correspond to the front surface and the second surface may be arranged between the first end and the second end. In addition, when viewed in the cross section, the front and rear surfaces of the square like form may extend along a direction perpendicular to the extension direction. At least one edge formed by one of the side surfaces and the front surface or the rear surface may be configured as an opening arranged to receive the at least one end cap. As an option, the opening of the square like form may seal with or may seal the at least one end cap.

In other words, the square like form may be hollow, wherein said inner hollow space may be connected to the inner space of the hollow ceramic jacket. The opening formed at the edge may connect the hollow space of the square like form to the environment of the fiber insulator.

Here, the term “edge of the square like form” is used to specify the position of an opening configured to receive at least one end cap. Of course, said edge is no longer physically present if the edge is configured as an opening.

At least two edges of the square like form can be configured as openings, each opening being configured to receive a respective end cap.

Both openings may be connected to the inner hollow space of the square like form.

When viewed in the cross-section, the at least two openings of the square like form can be formed at the edges corresponding to the side surfaces connecting to the front surface.

By providing at least two openings sealed by respective end caps, it is possible to feed in the fiber optical cable via a first end cap in a state when the filling material is not yet introduced into the hollow jacket. The fiber optical cable can be arranged as desired and the corresponding end cap seals one opening together with the fiber optical cable. The second opening may then be used to fill in the filling material and can be sealed after at least partially filling or filling out the ceramic jacket by the second end cap afterwards. Therefore, the assembly of the insulator and the fiber optical cable is simplified.

The filling material may fill out at least partially the hollow ceramic jacket as well as the hollow space of the square like form. Thereby an insulating effect of the insulator for the fiber optical cable is guaranteed.

The fiber optical cable may comprise a hollow tube extending along the fiber cable extension direction, at least one fiber extending along a fiber cable extension direction and arranged within the hollow tube, and a special gel arranged in the hollow tube and arranged at least partially between the at least one fiber and the hollow tube when viewed in a cross section extending perpendicular to the fiber cable extension direction. The hollow tube may have at least a first section and a second section. The first section of the hollow tube may be arranged inside the fiber insulator and the second section may be arranged outside the fiber insulator. The second section may extend from the at least one end cap away from the at least one end cap (along the fiber optical cable extension direction). An outer surface of the second section of the hollow tube may be covered by a high resistant aramid yarn. An outer surface of the high resistant aramid yarn may be covered by a polyurethane, polyethylene or cross-linked polyethylene/flame retardant non-corrosive jacket.

The fiber optical cable opening or the at least one end cap may be configured to fix the second section of the hollow tube. The fiber optical cable opening or the at least one end cap may be configured to be fixed with the high resistant aramid yarn and/or the non-corrosive jacket. That is, the second section of the hollow tube can have the high resistant aramid yarn and the non-corrosive jacket and an end arranged at the fiber optical cable opening or the at least one end cap can be fixed to the fiber optical cable opening or the last one end cap. In other words, the jacket and the aramid yarn may be fixed with the cable gland and at the end of the fiber insulator in or at the at least one end cap.

The aramid yarn and the non-corrosive jacket may be removed or not present at the first section, because the aramid yarn might soak in water and become a voltage transmitting medium.

By fixing the second section of the hollow tube and/or fixing the fiber optical cable opening/the at least one end cap to the high resistant aramid yarn and/or the non-corrosive jacket, it is possible that, e.g., any pulling force applied to the fiber optical cable applies to the aramid yarn, the non-corrosive jacket and the at least one end cap and/or fiber optical cable opening of the at least one end cap, but not to the fiber. Thereby, the signal quality of the fiber optical cable can be further improved in an application in which such forces apply or where the fiber optical cable is moved.

By using the jacket of the named materials, it is possible to provide a fiber optical cable withstanding the required environmental impacts.

Furthermore, by providing the high resistant aramid yarn, the mechanical performance of the fiber optical cable may be increased. In particular, the aramid yarn improves tensibility and crust strength leading to a strong increase and resistance to repeated bending and torsion of the fiber optical cable.

By providing the special gel inside the hollow tube between the at least one fiber and the hollow tube, it is possible to attenuate or even decouple movement of the hollow tube from movement of the at least one fiber. Since an optical signal transmitted via the at least one fiber is very sensitive to any movement of the at least one fiber and in order to reduce or even eliminate noise or deterioration of the transmitted optical signal, the special gel may be provided between the hollow tube and the at least one fiber. The special gel can absorb or attenuate any movement of the hollow tube without transferring the movement to the at least one fiber. Therefore, it is possible to use such a fiber optical cable in applications where it is necessary to move the fiber optical cable without deteriorating the optical signal.

The hollow tube can be a loose tube. In particular, the second section of the hollow tube can be a loose tube.

The special gel can have a specific velocity configured to only partially transmit movement and/or rotation of the hollow tube to the at least one fiber or wherein the special velocity may be configured to decouple movement and/or rotation of the hollow tube from movement of the at least one fiber.

The special gel can have the specific viscosity configured to not move or drip out at the fiber optical cable ends even if the fiber optical cable is arranged in a position in which the fiber optical cable extends in a fiber optical cable extension direction parallel to the earth's gravitational pull.

In other words, the viscosity of the special gel may be set such that the fiber optical cable can even be held in a vertical direction without the special gel moving or drip-ping out at the fiber optical cable ends.

The hollow tube can be made of a dual layer hollow tube. The dual layers may be polycarbonate and polybutylene terephthalate. This allows the fiber optical cable to be used in different temperature ranges. Alternatively, the hollow tube can be made of polyamide, ethylene tetrafluoroethylene or polybutylene terephthalate. Polybutylene terephthalate can be used as a suitable material in a moderate environment such as the environment in Europe.

The hollow tube can be a loose hollow tube.

The high resistant aramid yarn may provide the necessary pullforce, bending and torsion performance of the fiber optical cable.

According to another embodiment of the present invention, there is provided a system comprising an insulator according to any of the aspects of the insulator mentioned before. The fiber optical cable of or provided in the system may a fiber optical cable according to any of the aspects of the fiber optical cable mentioned before.

The disclosure of the present application is explained with the following figures. The attached figures show:

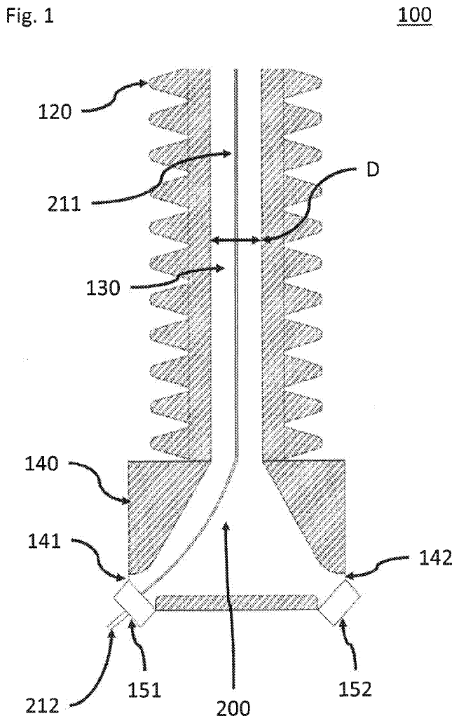

FIG. 1 a cross sectional view of a fiber insulator according to the present invention;

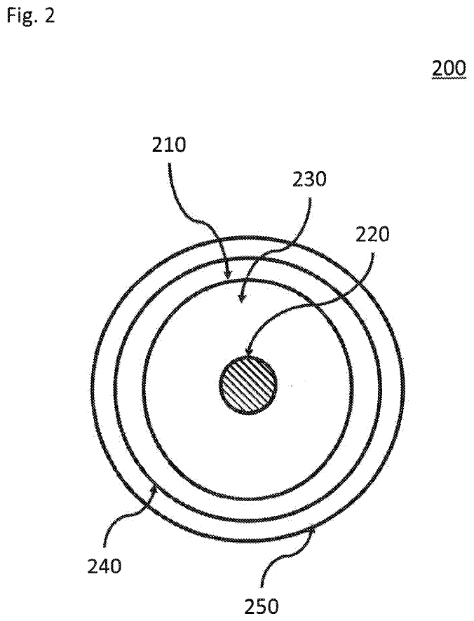

FIG. 2 a cross sectional view of a fiber optical cable according to the present invention; and

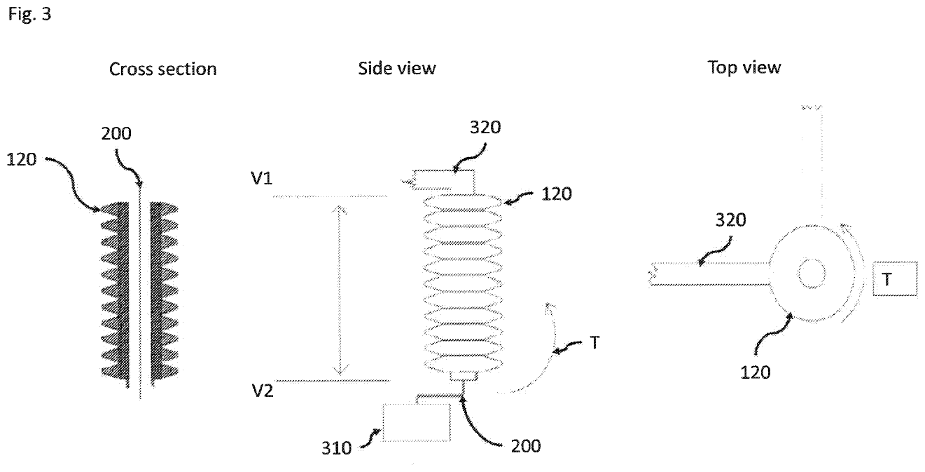

FIG. 3 a cross sectional view, a side view and a top view of an example application of the fiber insulator and the fiber optical cable.

The following description of the drawings serves explanation purposes and should not be construed as limiting the claims and scope of the invention to specific details thereof. Furthermore, the measurements and sizes of the figures do not necessarily have to correspond to reality and are drawn for explanation purposes.

FIG. 1 shows a cross sectional view of a fiber insulator 100 according to the present invention. The cross sectional view extends in the drawing plane. The fiber insulator 100 comprises a fiber optical cable 200, a ceramic jacket 120 and an insulating filling material 130. The fiber optical cable has the reference sign 200 in FIG. 1, however, the fiber optical cable 200 in FIG. 1 may have a different configuration than the fiber optical cable illustrated in FIG. 2. Of course, the fiber optical cable may be the fiber optical cable 200 described with reference to FIG. 2.

The ceramic jacket 120 is hollow and has an inner whole diameter D configured to guide the fiber optical cable 200 along an extension direction of the fiber insulator 100 or the fiber optical cable 200. As apparent from FIG. 1, the diameter D of the ceramic jacket 120 is set to be greater than a diameter of the fiber optical cable 200 to allow the fiber optical cable 200 to be fed through the fiber insulator 100. In particular, the diameter D of the ceramic jacket 120 is set such that insulating filling material 130 can be filled into the hollow ceramic jacket 120 and be arranged between the fiber optical cable 200 and the ceramic jacket 120. The insulating material 130 is electrically insulating. The insulating filling material 130 has thermal properties configured to compensate thermal properties of at least one of the fiber optical cable 200 and the ceramic jacket 120. That is, the thermal properties of the insulating material 130 are set/configured such that it can compensate, e.g., heat transferred or absorbed by the ceramic jacket 120, which is not transmitted to the fiber optical cable 200. In other words, the thermal properties of the insulating material 130 can be configured to be temperature isolating.

The insulating filling material 130 may be a material which can be firstly provided in a fluid or gel like condition for being filled into the ceramic jacket 120. Once the fiber optical cable 200 and the insulating filling material 130 are provided inside the ceramic jacket 120, the insulating filling material 130 can harden and become a long term stable, electrically and temperature insulating part of the fiber insulator 100. Moreover, at least one end of the fiber insulator 100 is closed by at least one end cap 151, 152.

By providing the insulating filling material 130 at least partially inside the ceramic jacket 120 and at least partially arranged between the fiber optical cable 200 and the ceramic jacket 120, the insulating performance of the fiber insulator 100 is improved and any optical signals transmitted via the fiber optical cable 200 can be shielded against disruptive environmental influences, such as high voltage environments.

As apparent from FIG. 1, an outer surface of the ceramic jacket 120 has an undulating shape and an inner surface of the ceramic jacket 120 faces the fiber optical cable 200. In particular, the inner surface of the ceramic jacket 120 has a smooth surface to allow a simplified feeding through of the fiber optical cable 200 and an improved filling process of the insulating filling material 130. This provides an increased creepage distance compared to a smooth outer surface (smooth rob), wherein the longer creepage distance contributes to the insulation level of the insulator 100.

Furthermore, as apparent from FIG. 1, the fiber optical cable 200 or an hollow tube 210 thereof has a first section 211 and a second section 212. The first section 211 is arranged within/inside the fiber insulator 100, in particular, within the ceramic jacket 120. The second section 212 is arranged outside the fiber insulator 200. As illustrated in FIG. 1, the second section 212 extends from the at least one end cap 151 along the extension direction of the fiber optical cable 200 to the bottom part of FIG. 1. Thus, the second section 212 extends away from the at least one end cap 151.

In FIG. 1, the second section 212 extends from an outer surface of the at least one end cap 151. The first section 211 extends at least from an inner surface opposite the outer surface of the at least one end cap 151 along the inside of the ceramic jacket 120.

FIG. 1 only shows a bottom part of the fiber insulator 100 and a corresponding bottom end thereof. Of course, the fiber insulator 100 can have a top part also having an end of the fiber insulator 100 which may be identically configured to the bottom end illustrated in FIG. 1.

The at least one end of the fiber insulator 100 has a square like form in FIG. 1. In particular, FIG. 1 shows a rectangular form of the at least one end of the fiber insulator 100. Said square like form is hollow and is connected to the inner space of the hollow ceramic jacket 120. Moreover, the square like form has a front surface, a rear surface and two side surfaces in the cross section view of FIG. 1. Of course, when seen in a three dimensional manner, at least four side surfaces are provided. The front and rear surface are connected by the two side surfaces to form the square like form. In addition, the front and rear surface of the square like form extend perpendicular to the extension direction of the fiber insulator 100. As apparent from FIG. 1, the front and rear surfaces of the square like form extend beyond the undulating shape of the ceramic jacket 120.

Furthermore, the square like form has two openings 141, 142 formed at the lower corners/edges of the square like form when viewed in FIG. 1. Each of the openings 141, 142 may be provided with an end cap 151, 152. The end caps 151, 152 may be configured to close, and as an option, seal the openings 141, 142 to protect the insulating filling material 130 as well as making the filling process possible. The fiber optical cable 200 passes through a fiber optical cable opening of the end cap 151. The configuration of the fiber insulator according to FIG. 1 allows a simple and time efficient construction of the fiber insulator 100. That is, the fiber optical cable 200 can be fed through the fiber optical cable opening of the end cap 151 and can thus be arranged within the fiber insulator 100 in an easy manner. Namely, it is easy to pass the fiber optical cable 200 through the end cap 151 and pull it through the fiber insulator 100, while the end cap 151 maintains its position at the opening 141 during pulling of the fiber optical cable. Secondly, the other opening 142 can be used before or after arrangement of the fiber optical cable 200 for filling in the insulating filling material 130. Since the opening 142 can have a greater diameter than the fiber optical cable 200 and can still be sealed or closed by the end cap 152, an efficient filling process is achieved. Also the openings 141, 142 are connected to the inner whole space of the square like form to enable the optical cable 200 to pass through it and to allow introduction of the insulating filling material 130.

The end caps 151, 152 can be configured to seal the openings 141, 142 with or without the fiber optical cable 200.

The at least one end cap 151, 152 may be configured as a plug to close the at least one end of the fiber insulator 100. In particular, the at least one end cap 151, 152 may have a disc or plug like shape with a radius corresponding to or slightly smaller than a radius of the opening 141, 142.

FIG. 2 shows a cross sectional view of a fiber optical cable 200 according to the present invention. The cross sectional view of FIG. 2 is perpendicular to the cross sectional view of FIG. 1 and is a cross section view of the fiber optical cable 200 at the second section 211. The fiber optical cable 200 comprises a hollow tube 210 extending along a fiber cable extension direction as previously presented with respect to FIG. 1. The fiber optical cable 200 further comprises at least one fiber 220 extending along the fiber cable extension direction, wherein the at least one fiber 220 is arranged within the hollow tube 210. There may be provided two or more fibers 220 inside the hollow tube 210. Moreover, a special gel 230 is arranged in the hollow tube 210 and at least partially between the at least one fiber 220 and the hollow tube 210. An outer surface of the second section 211 of the hollow tube 210 is covered by a high resistance aramid yarn 240, wherein an inner surface of the hollow tube 210 faces the at least one fiber 220. Moreover, an outer surface of the high resistant aramid yarn 240 is covered by a polyurethane, polyethylene or cross-linked polyethylene/flame retardant non-corrosive jacket 250.

By arranging the special gel 230 inside the hollow tube 210 and, in particular, between the fiber optical cable 200 and the inner surface of the hollow tube 210, it is possible to attenuate any movement of the hollow tube 210 such that less movement or even no movement is transmitted via the special gel 230 to the at least one fiber 220. In other words, due to the velocity of the special gel 230, it is possible to decouple or attenuate any movement of the hollow tube 210 from movement of at least one fiber 220. This is beneficial since any small movement or vibration applied to the at least one fiber 220 may have an impact on a transmitted optical signal and may deteriorate the optical signal. By reducing said impact or even eliminating the impact, it is possible to perform highly sensitive measurements and transmitting corresponding optical signals via the fiber optical cable 200 without or less deteriorated reception at a corresponding measurement station.

In particular, the velocity of the special gel 230 can be configured or set to a velocity to only partially transmit movement and/or rotation of the hollow tube to the at least one fiber 220. Moreover, the special gel 230 has the velocity configured to not more or drip out at the fiber optical cable ends even if the fiber optical cable 200 is arranged in a position in which the fiber optical cable 200 extends in a fiber optical cable extension direction parallel to the earth's gravitational pull.

The hollow tube 210 can be made of a dual layer hollow tube, wherein the dual layers are polycarbonate and polybutylene terephthalate. Alternatively, the hollow tube 210 can be made of polyamide, ethylene tetrafluoroethylene or polybutylene terephthalate. For a moderate environment such as in Europe, a polybutylene terephthalate could be used.

Moreover, the hollow tube 210 can be configured as a loose hollow tube. That means, the hollow tube 210 is not tensioned between the two ends of the fiber optical cable, but may rest in a loose configuration. This is further beneficial for attenuating movement of the fiber optical cable 200.

Now, with reference to FIG. 1 again, the second section 211 of the fiber optical cable 200 being comprised of the hollow tube 210, the at least one fiber 220, the special gel 230, the high resistant aramid yarn 240 and the non-corrosive jacket 250 is fixed to the at least one end cap 151. In particular, at least the high resistant aramid yarn 240 and the non-corrosive jacket 250 are fixed to the at least one end cap 151.

By fixing only the high resistant aramid yarn 240 and the non-corrosive jacket 250, while the hollow tube 210 can be regarded as a loose tube, for example a pull force applied to the fiber optical cable 200 applies to the high resistant aramid yarn 240 and the non-corrosive jacket 250 and not the loose tube, in particular, not the fiber 220. The pull force is directed to the at least one end cap 151 and may be to the fiber insulator 100. Accordingly, the fiber 220 is protected from external forces applied to the fiber optical cable 200 increasing the shelf life of the fiber optical cable 200 as well as protecting the transmission properties of the fiber 220, which would otherwise decrease or be deteriorated.

FIG. 3 shows three different views, namely a cross sectional view, a side view and a top view of an example application of the present invention. At the cross sectional view, the fiber insulator 100 according to FIG. 1 is shown with the fiber optical cable 200. The side view shows the fiber insulator 100 with an arm 320 of a Breaking-closing disconnecting switch (BCDS) arranged at an upper end of the fiber insulator 100. The fiber optical cable 200 is connected to a measurement station 310 and passes through a lower end of the fiber insulator 100. The optical fiber cable 200 is guided by the fiber insulator 100 to the upper end and is fed through the arm 320 to an optical measurement position. Moreover, as exemplarily illustrated in the side view, at the environment at the upper end of the fiber insulator 100, a voltage of V1 is applied where the optical measurement position is. In addition, a voltage V2 is present in the environment at the lower end. The differences between the voltages V1 and V2 may be between 50 kV to 250 kV. As exemplarily illustrated in the side view, a turn arrow T is shown, see also the top view. It may be necessary for such an optical measurement to move or turn the arm 320 to another measurement or off position. If the arm 320 is turned as illustrated by the arrow T, the torsion is also applied to the fiber optical cable 200. It was already explained above that the optical signals transmitted via the fiber optical cable 200 can be very sensitive and thus such a torsion would deteriorate the optical signal. Since the optical fiber cable 200 can be configured as the optical fiber cable 200, it is possible to reduce the deteriorating effect of the torsion via the special gel 230. Accordingly, it is possible to move the optical measurement arrangement with the fiber insulator 100 and the fiber optical cable 200 without having a deteriorated optical signal.

1. Fiber insulator (100) with a fiber optical cable (200), comprising:
a fiber optical cable (200);
a ceramic jacket (120), wherein the ceramic jacket (120) is hollow,
wherein the ceramic jacket (120) has an inner whole diameter (D) configured to guide the fiber optical cable (200);
an insulating filling material (130), which at least partially fills out the ceramic jacket (120) and is arranged between the fiber optical cable (200) and the ceramic jacket (120), and
wherein at least one end of the fiber insulator (100) is closed by at least one end cap (151, 152) configured to close the at least one end of the fiber insulator (100),
wherein the at least one end cap (151, 152) is configured such that the fiber optical cable (200) passes through the at least one end cap.

2. Fiber insulator (100) according to claim 1,
wherein an outer surface of the ceramic jacket (120) has an undulating shape and an inner surface of the ceramic jacket (120) faces the fiber optical cable (200).

3. Fiber insulator (100) according to claim 1 or 2,
wherein the insulating filling material (130) has thermal properties configured to compensate thermal properties of at least one of the fiber optical cable (200) and the ceramic jacket (120).

4. Fiber insulator (100) according to any of claims 1 to 3,
wherein the at least one end cap (151, 152) is configured to seal the at least one end of the fiber insulator (100), and/or
wherein the at least one end cap (151, 152) is configured to fix the fiber optical cable (200) such that movement of the fiber optical cable (200) along a fiber optical cable extension direction is prevented.

5. Fiber insulator (100) according to claim 4,
wherein the at least one end cap (151, 152) has a fiber optical cable opening, the fiber optical cable opening being arranged such that the fiber optical cable (200) passes through the fiber optical cable opening into the fiber insulator (100),
wherein, as an option, the fiber optical cable opening is configured to seal with the fiber optical cable (200) when the fiber optical cable (200) passes through the fiber optical cable opening.

6. Fiber insulator (100) according to any of claims 1 to 5,
wherein the at least one end of the fiber insulator (100) has a square like form when viewed in a cross section extending along an extension direction of the fiber insulator (100),
wherein, when viewed in the cross section, the square like form has a front surface and a rear surface parallel to the front surface and said front and rear surfaces being connected by side surfaces,
wherein the fiber insulator (100) extends from the front surface of the square like form along the extension direction,
wherein, when viewed in the cross section, the front and rear surfaces of the square like form extend along a direction perpendicular to the extension direction, and
wherein at least one edge formed by one of the side surfaces and the front surface or the rear surface is configured as an opening (141, 142) arranged to receive the at least one end cap (151, 152),
wherein, as an option, the opening (141, 142) of the square like form seals with the at least one end cap (151, 152).

7. Fiber insulator (100) according to claim 6,
wherein at least two edges of the square like form are configured as openings (141, 142) configured to receive at least one respective end cap (151, 152).

8. Fiber insulator (100) according to claim 7,
wherein, when viewed in the cross-section, the at least two openings (141, 142) of the square like form are formed at the edges corresponding to the side surfaces connecting to the front surface.

9. Fiber insulator (100) according to any of the preceding claims, wherein the fiber optical cable (200) comprises:
a hollow tube (210) extending along the fiber cable extension direction;
at least one fiber (220) extending along the fiber cable extension direction and arranged within the hollow tube (210); and
a special gel (230) arranged in the hollow tube (210) and at least partially between the at least one fiber (220) and the hollow tube (210),
wherein the hollow tube (210) has at least a first section (211) and a second section (212),
wherein the first section (211) of the hollow tube (210) is arranged inside the fiber insulator and the second section (212) is arranged outside the fiber insulator, the second section (212) extending from the at least one end cap away from the at least one end cap along the fiber cable extension direction,
wherein an outer surface of the second section (212) of the hollow tube (210) is covered by a high resistant aramid yarn (240),
wherein an outer surface of the high resistant aramid yarn (240) is covered by a polyurethane, polyethylene or cross-linked polyethylene/flame retardant non-corrosive jacket (250).

10. Fiber insulator (100) according to claim 9, wherein the fiber optical cable opening is configured to fix the second section of the hollow tube (210).

11. Fiber insulator (100) according to claim 9 or 10, wherein the fiber optical cable opening is configured to be fixed with the high resistant aramid yarn and/or the non-corrosive jacket (250).

12. Fiber insulator (100) according to any of claims 9 to 11,
wherein the special gel (230) has a specific velocity configured to only partially transmit movement and/or rotation of the hollow tube (210) to the at least one fiber (220) or wherein the special velocity is configured to decouple movement and/or the rotation of the hollow tube (210) from movement of the at least one fiber (220), and/or
wherein the special gel (230) has the specific viscosity configured to not move or drip out at the fiber optical cable ends even if the fiber optical cable (200) is arranged in a position in which the fiber optical cable (200) extends in a fiber optical cable extension direction parallel to the earth's gravitational pull.

13. Fiber insulator (100) according to any of claims 9 to 12,
wherein the hollow tube (210) is made of a dual layer hollow tube, the dual layers being polycarbonate and polybutylene terephthalate, or
wherein the hollow tube (210) is made of polyamide, ethylene tetrafluoroethylene or polybutylene terephthalate.

14. Fiber insulator (100) according to any of claims 9 to 13,
wherein the hollow tube (210) is a loose hollow tube.
